(19) United States
(12) Patent Application Publication
(10) Pub. No.: US 2026/0339583 A1
(43) Pub. Date: Oct. 29, 2026

(54) NON-TRANSITORY COMPUTER-READABLE STORAGE MEDIUM STORING SUPPORTING PROGRAM

(71) Applicant: BROTHER KOGYO KABUSHIKI KAISHA, Nagoya (JP)

(72) Inventors: Tatsuhiko SONE, Nagoya (JP); Kenju NARITA, Nagoya (JP); Airi EGUCHI, Ichinomiya (JP)

(21) Appl. No.: 19/561,926

(22) Filed: Mar. 10, 2026

(30) Foreign Application Priority Data
Apr. 28, 2025 (JP) 2025-074480

(51) Int. Cl. G06F 3/12

(52) U.S. Cl. CPC G06F 3/126; G06F 3/1205; G06F 3/1274

(57) ABSTRACT

A non-transitory computer-readable storage medium storing a support program that causes the information processing apparatus to perform operations. The operations include identifying a physical printer that is a control target of a virtual printer associated with the support program, setting a name of a first printer queue of the virtual printer as an identification name of the physical printer identified in the identifying, and, in a case where, when an application program of the information processing apparatus displays a printer selection screen displaying the first printer queue of the virtual printer with the identification name, and the first printer queue of the virtual printer is selected on the printer selection screen, an operating system of the information processing apparatus issues an instruction to display a print settings screen, displaying, on a user interface of the information processing apparatus, the print settings screen based on capabilities of the physical printer identified.

### REFERENCE TO RELATED APPLICATIONS

This application claims priority from Japanese Patent Application No. 2025-074480 filed Apr. 28, 2025. The entire content of the priority application is incorporated herein by reference.

### BACKGROUND ART

A known technique controls a printer using an OS-standard printing function constituting a part of an operating system (OS). In the above-described technique, the OS, upon detecting a printer, associates the printer with a standard universal printing program. In a configuration that uses the OS-standard universal printing program, printer drivers provided by printer vendors are not used. For a printer associated with the OS-standard universal printing program, printing via the universal printing program is enabled when a print command for the printer is received.

One disclosure of a technique for controlling a printer using an OS-standard printing function, without using a printer driver, is known in the prior art. The disclosure describes an information processing apparatus that is connected to a printer that does not support the OS standard driverless printing function. The information processing apparatus starts a print server program registered as a virtual printer. When the print server program is started, the information processing apparatus is able to accept print jobs that designate which the print server program as the output destination. The print server program, upon receiving a print job, generates print data compatible with the printer. The print data is then transmitted to the printer.

### SUMMARY

A configuration using the OS-standard printing function allows for the installation of a support program that executes processing based on an instruction from the OS in conjunction with the OS-standard printing processing. Since the support program operates in cooperation with the OS, the OS-standard printing function can be expected to be enhanced. Thus, printing that effectively utilizes virtual printers in the configuration having the support program is recommended.

According to an aspect of the disclosure, a non-transitory computer-readable storage medium storing a support program that causes the information processing apparatus to perform operations. The operations include identifying a physical printer that is a control target of a virtual printer associated with the support program, setting a name of a first printer queue of the virtual printer as an identification name of the physical printer identified in the identifying, and, in a case where, when an application program of the information processing apparatus displays a printer selection screen displaying the first printer queue of the virtual printer with the identification name, and the first printer queue of the virtual printer is selected on the printer selection screen, an operating system of the information processing apparatus issues an instruction to display a print settings screen, displaying, on a user interface of the information processing apparatus, the print settings screen based on capabilities of the physical printer identified.

The support program described above sets the name of the printer queue of the virtual printer to the identification name of the physical printer that is the control target. Thus, when a printer is selected in an editing application or similar software, the virtual printer is displayed with the identification name of the physical printer identified as the control target, rather than with the predetermined name of the virtual printer. Thus, the user can easily select the printer. Furthermore, the user can easily understand which printer is set as the control target for the virtual printer.

A control method for realizing the functions of the apparatus and a computer-readable storage medium storing the computer program are also novel and useful.

According to the technology disclosed in the present specification, the OS-standard printing function and the support program are coordinated to effectively use a virtual printer.

### BRIEF DESCRIPTION OF THE DRAWINGS

FIG. 1 is a block diagram schematically illustrating an electrical configuration of a personal computer.

FIG. 2 is a sequence diagram illustrating an example of an installation procedure.

FIG. 3 is a diagram illustrating an example of a printer list screen immediately after an auxiliary program is installed.

FIG. 4 is a diagram illustrating a home screen of an auxiliary program for a virtual printer.

FIG. 5 is a sequence diagram illustrating an example of a procedure for identifying a printer that is a control target.

FIG. 6 is a diagram illustrating an example of a printer list screen after the name of a virtual printer queue is changed.

FIG. 7 is a sequence diagram illustrating an example of a print settings procedure.

FIG. 8 illustrates an example of a print settings screen.

FIG. 9 is a sequence diagram illustrating an example of a procedure for executing printing on a printer that is a control target.

FIG. 10 is a sequence diagram illustrating an application example of a procedure for changing a name of a virtual printer queue.

FIG. 11 is a sequence diagram illustrating an example of a procedure for adding a new virtual printer queue.

FIG. 12 is a diagram illustrating a home screen of an auxiliary program for a virtual printer.

FIG. 13 is a sequence diagram illustrating an example of a procedure for adding a new virtual printer via intermediate application.

FIG. 14 is a sequence diagram illustrating an example of a procedure for synchronizing a virtual printer queue and cache.

FIG. 15 is a sequence diagram illustrating an example of a procedure for synchronizing a virtual printer queue and cache.

FIG. 16 is a diagram illustrating an example of a printer list screen after the name of a virtual printer queue is changed.

### DESCRIPTION

Hereinafter, a personal computer (hereinafter, referred to as “PC”) using a supporting program of an embodiment will be described in detail with reference to the accompanying drawings. The disclosure describes the supporting program executable by the PC.

### PC Configuration

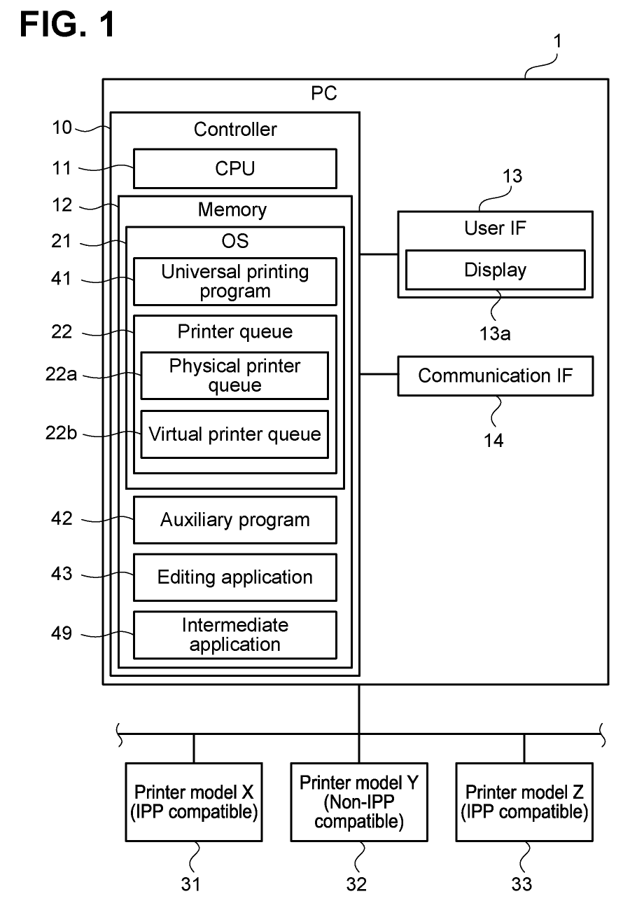

As illustrated in FIG. 1, a PC 1 of the embodiment includes a controller 10 including a CPU 11 and a memory 12. The PC 1 is an example of an information processing apparatus. The CPU 11 is an example of a computer. The PC 1 includes a user interface (hereinafter, referred to as a "user IF") 13 and a communication interface (hereinafter, referred to as a "communication IF") 14. The user IF 13 and the communication IF 14 are electrically connected to the controller 10. The term “controller 10” may be a collective term for hardware and software used to control the PC 1, and might not necessarily represent a single piece of hardware that is actually in the PC 1.

The CPU 11 executes various processes in accordance with a program read from the memory 12 or based on user input. The memory 12 stores various programs and various types of data. The memory 12 is also used, for example, as a work area for executing various programs. Examples of the memory 12 include a buffer included in the CPU 11. Examples of the memory 12 further include, but are not limited to a ROM incorporated in the PC 1, and recording media that are readable and writable by the CPU 11, such as a CD-ROM and a DVD-ROM.

The user IF 13 includes a display 13a, which is hardware for displaying information to a user. Further, the user IF 13 includes hardware for user input. The user IF 13 may include a combination of a display 13a capable of displaying information and input devices such as a mouse or keyboard having input reception functions. The user IF 13 may also include a touch panel having a function of the display 13a and an input reception function.

The communication IF 14 includes hardware for communicating with external devices. Examples of communication standards for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 stores an operating system (hereinafter, referred to as “OS”) 21 including a universal printing program 41. Further, the memory 12 can store various programs and various types of data including an auxiliary program 42, an editing application 43, and an intermediate application 49. The auxiliary program 42 is an example of a support program. In the present specification, the application program may also be referred to as an "application".

The OS 21 is a multitasking OS that manages and switches between multiple tasks, thereby executing multiple tasks simultaneously. The OS 21 may be, for example, Windows, macOS, Linux, iOS, or Android. Windows is a trademark of the Microsoft group of companies. macOS is a registered trademark of Apple Inc. Linux is a registered trademark of Linus Torvalds. iOS is a registered trademark of Cisco Systems, Inc. Android is a registered trademark of Google LLC.

The OS 21 includes the universal printing program 41 and a printer queue 22. The universal printing program 41 is an OS-standard program that is developed by a vendor of the OS 21 and provided as part of the OS 21. The universal printing program 41 is packaged with, for example, the OS 21 and installed on the PC 1. That is, the PC 1 is equipped with the OS 21 including the universal printing program 41. In other words, the OS 21 includes an OS-standard universal printing program 41. The universal printing program 41 is not configured to use printer-specific drivers.

The universal printing program 41 has a function for executing printing on various types and models of printers provided by different vendors. The universal printing program 41 provides general functions that enable various printers to perform printing. The universal printing program 41 can communicate with various printers that support IPP, for example, through communication based on IPP. IPP stands for Internet Printing Protocol. Unlike printer drivers specific to each printer, the universal printing program 41 does not provide functions that are specific to each printer or printer driver. As an example of the universal printing program 41, IPP Class Driver provided by Microsoft Corporation may be used.

The universal printing program 41 receives image data designated as print targets in print instructions output from various application programs, based on user instructions. The universal printing program 41 then generates intermediate data based on the received image data. The intermediate data is, for example, XPS data. The universal printing program 41 further includes a function that generates print data, in formats usable for printing by various printers, based on the intermediate data. The print data is, for example, PDF data. The universal printing program 41 further includes a function that transmits the generated print data to a printer designated as a device for performing printing, using a communication function of the OS 21.

The OS 21 can register, as a printer queue 22, a physical printer queue 22a corresponding to a physical printer. Since a physical printer queue 22a can be registered for each physical printer, the OS 21 can provide multiple physical printer queues 22a. The OS 21 can also register, as a printer queue 22, a virtual printer queue 22b corresponding to a virtual printer. The OS 21 can also provide multiple virtual printer queues 22b. The printer queue 22 is also referred to as a print queue.

The auxiliary program 42 consists of a single program or a group of programs that operates in conjunction with the universal printing program 41 to execute processing based on instructions from the OS 21. The auxiliary program 42 is an application program for controlling the target hardware, such as a printer for printing. The auxiliary program 42 of this embodiment corresponds to a printer model and is supplied by, for example, a printer vendor. When a predetermined printer is selected as a printer to perform printing, the universal printing program 41 starts the auxiliary program 42 associated with the predetermined printer. When the universal printing program 41 receives a detailed print setting instruction while the predetermined printer is selected, the universal printing program 41 also starts the auxiliary program 42 associated with the predetermined printer. When the universal printing program 41 receives an instruction to cause a predetermined printer to execute printing, the universal printing program 41 also starts the auxiliary program 42 associated with the predetermined printer. The auxiliary program 42 is, for example, referred to as a Print Support Application (abbreviated as PSA). Alternatively, the auxiliary program 42 may be referred to as a Hardware Support Application (abbreviated as HSA).

The auxiliary program 42 of the present embodiment also corresponds to a virtual printer. When a virtual printer queue 22b is provided, the universal printing program 41 allows selection of a virtual printer as a printer to perform printing. The universal printing program 41 thus starts the auxiliary program 42 also when a virtual printer is selected as a printer to perform printing.

The auxiliary program 42 may be a combination of multiple programs, or may be a single program that can execute different processes in accordance with instructions. Auxiliary programs may be prepared for different types of printers by printer vendors. For example, an auxiliary program for an inkjet printer or an auxiliary program for a laser printer may be prepared. Auxiliary programs may be provided not only for types of printers, but also for different printer models or different series of printer models.

When the OS 21 detects connection of a new printer to the PC 1, the OS 21 can download and install an appropriate auxiliary program 42 in accordance with the detected printer model. The OS 21 can download the auxiliary program 42 from, for example, a server of a printer vendor or a website designated by the OS 21. The OS 21 stores identification data of the installed auxiliary program 42 into the memory 12 in association with printer information of the newly connected printer. In this specification, the detection of a new printer being connected to the PC 1 by the OS 21 is also simply referred to as detection of a printer. The timing of installing the auxiliary program 42 is not limited to when a printer is detected. For example, a file for installing the auxiliary program 42 may be distributed to the PC by an administrator, and installation may be performed from the distributed file.

The editing application 43 is, for example, a program for creating and editing image data and document data. The editing application 43 may be, for example, Microsoft Word or Microsoft PowerPoint ™developed by Microsoft ™ or may be a program provided by any of various printer vendors. The editing application 43 can receive, via the user IF 13, instructions such as a print selection instruction and a print execution instruction to cause the printer to perform printing. The editing application 43 is not limited to a program for creating or editing data. The editing application 43 may also be a program having a function of receiving instructions to display or print various types of information, such as map information or web pages, in response to a user request.

The intermediate application 49 is a Win32 application located outside the sandbox in which the auxiliary program 42 is located. The intermediate application 49 is located outside of the sandbox and is not restricted by the OS 21 from operations such as adding of printer queues. Thus, the intermediate application 49 can mediate between the auxiliary program 42 and other applications. The intermediate application 49 is used in an application example, which will be described in a second embodiment below. Thus, in the embodiments other than the application example of the second embodiment, the intermediate application 49 may not be stored in the memory 12. The intermediate application 49 is an example of an intermediate program.

The PC 1 is connectable to various printers having a printing function and a communication function. The various printers include printers that support IPP, which is a communication protocol used by the universal printing program 41, and printers that do not support IPP. When a printer that supports IPP is detected, the OS 21 creates a physical printer queue corresponding to the detected printer. The OS 21 installs an auxiliary program supplied by the printer vendor for the detected printer. The OS 21 is configured to automatically associate the detected printer with the installed auxiliary program. Thus, the universal printing program 41 can accept the selection of the detected printer that supports IPP as a printer to be used for printing.

In contrast, even if a printer that does not support IPP is detected, the detected printer cannot receive print instructions transmitted from the universal printing program 41 in accordance with IPP. Thus, the OS 21 does not create a physical printer queue even if a printer that does not support IPP is detected. Further, the OS 21 does not download an auxiliary program nor does not perform any association with the auxiliary program.

As illustrated in FIG. 1, the PC 1 of the present embodiment is connected to a printer 31, a printer 32, and a printer 33, each having a printing function. The printers connected to the PC 1 may have, in addition to a printing function, a scanning function, a copying function, a FAX transmission/reception function, and an e-mail transmission/reception function. In this specification, the term "printer(s)” is used to refer to devices including those having the functions described above. The printer 32 of this embodiment is as an example of an IPP-incompatible printer. The printer 31 and the printer 33 of the present embodiment are examples of IPP compatible printers. Examples of the printer 32 that is not compatible with IPP include label printers specialized in a function of printing on label paper, USB-only printers equipped solely with USB communication functions, and legacy printers equipped only with outdated communication functions. In this embodiment, the model name of the printer 31 is "Model X", the model name of the printer 32 is "Model Y", and the model name of the printer 33 is "Model Z".

### PC Control

The following describes procedures for various processes to perform printing on a printer, based on a print instruction to the universal printing program 41 in the PC 1 of the present embodiment. In this embodiment, the processes other than user operations are basically performed by the CPU 11 in accordance with the instructions described in the program such as the auxiliary program 42. In the present specification, for convenience, various processes executed by the controller 10 or the CPU 11 in accordance with respective programs may be described in such a manner that the respective programs independently execute the processes. Processing executed by the CPU 11 also includes control of hardware using APIs of the OS 21. In the specification, a description will be provided on operations of the programs. A detailed description of the OS 21 will be omitted.

Procedure for Installing Auxiliary Program for Virtual Printer

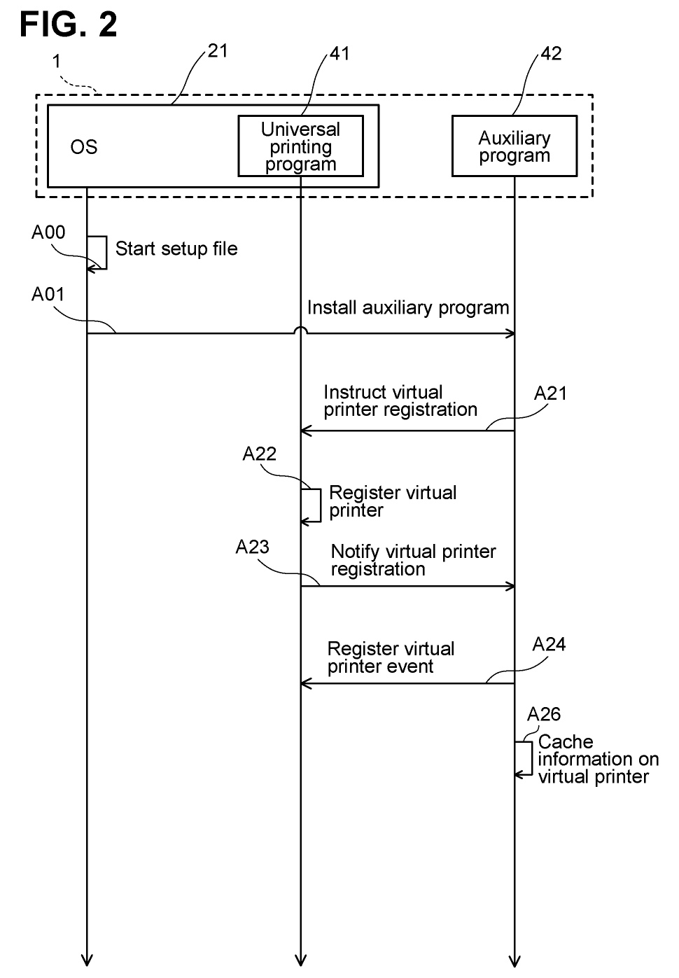

First, an installation procedure for installing an auxiliary program 42 for a virtual printer on the PC 1 will be described with reference to the sequence diagram of FIG. 2.

When the auxiliary program 42 for the virtual printer is installed, a setup file for installing the auxiliary program 42 is incorporated into the PC 1. Then, the setup file is started by the OS 21 (A00). For example, the setup file for installing the auxiliary program 42 is distributed to the PC 1 by an administrator or similar personnel. Alternatively, the setup file may be downloaded from a specified site through user operation. Subsequently, the PC 1 receives an instruction to open the setup file through user operation. Then, when the instruction to open the setup file is received, the OS 21 starts the setup file (A00).

The OS 21 installs the auxiliary program 42 for the virtual printer in the PC 1 based on the setup file thus started (A01). After the auxiliary program 42 for the virtual printer is installed, the OS 21 reads the manifest packaged with the installed auxiliary program 42. The manifest describes processing and operations to be executed during the installation of the auxiliary program 42.

The OS 21 associates the auxiliary program 42 with the virtual printer based on the processing instructions described in the manifest of the auxiliary program 42. That is, based on the processing instructions described in the manifest of the auxiliary program 42, the registration of the virtual printer is instructed (A21). The manifest of the auxiliary program 42 describes the information necessary for registering the virtual printer and the identification information of the auxiliary program 42 itself. The information necessary for registering the virtual printer includes, for example, file formats that can be supported and the name of the virtual printer queue.

The universal printing program 41 creates a virtual printer queue 22b and registers the virtual printer (A22). In A22, the universal printing program 41 stores, for example, the identification information described in the manifest of the auxiliary program 42 in the memory 12 in association with the information of the virtual printer queue 22b. After the completion of the step of A22, the universal printing program 41 notifies the auxiliary program 42 that the registration of the virtual printer has been completed (A23).

With the completion of the registration of the virtual printer, the universal printing program 41 can accept the selection of the virtual printer as a control target. The universal printing program 41 can accept a printer selection through a user operation in accordance with an instruction from the editing application 43, for example. That is, the universal printing program 41 receives a selection from the list of printer queues 22 provided in the OS 21, thereby accepting the printer selection. At this time, a printer list including the virtual printer queue 22b can be displayed together with the physical printer queue 22a provided in the OS 21.

In this embodiment, the installation of the auxiliary program 42 for the virtual printer enables the creation and registration of the virtual printer queue 22b in the OS 21. As a result, immediately after the installation, the virtual printer is available to be selected as a printer during printer selection in the editing application 43 or similar applications. However, only the virtual printer queue 22b is created, and no association is established between the virtual printer and a physical printer. That is, immediately after the installation of the auxiliary program 42, no physical printer is identified as the control target for the virtual printer. Thus, to control the physical printer using the virtual printer, identifying the physical printer to be set as the control target becomes necessary. The process for identifying the physical printer will be described later.

The auxiliary program 42 for the virtual printer sets the name of the virtual printer queue 22b when the virtual printer queue 22b is registered in A22. In this embodiment, the virtual printer queue 22b is set to a predetermined name that indicates that a printer as a control target has not yet been identified. Thus, the display name of the virtual printer becomes a predetermined name indicating that a printer as a control target has not yet been identified. For example, the name of the virtual printer queue 22b is set to "virtual printer with no connection destination". The user can recognize, by this display name, that the printer that is the control target of the virtual printer has not been identified.

The OS 21 registers various events for the virtual printer in the universal printing program 41 based on the processing instructions described in the manifest of the auxiliary program 42 (A24). Since the manifest is packaged with the auxiliary program 42, it can also be said that the auxiliary program 42 instructs the OS 21 to register the events. When the printer selected as the control target is a virtual printer, the universal printing program 41 issues an event for the virtual printer to the auxiliary program 42. The events for the virtual printer are different from those for when a physical printer is selected. The various events for the virtual printer include, for example, a virtual printer UI event and a virtual printer print event.

The auxiliary program 42, upon receiving the notification of A23, caches the information of the registered virtual printer queue 22b (A26). The cached information of the virtual printer queue 22b includes, for example, the name and the identification number of the virtual printer queue 22b. A26 is an example of a cache process.

As described above, when the auxiliary program 42 for the virtual printer is installed, one virtual printer queue 22b is provided in the OS 21. The installed auxiliary program 42 is associated with the single virtual printer queue 22b provided in the OS 21.

### Processing Procedure of Auxiliary Program

Next, a procedure for causing the PC 1 to execute various processes of the auxiliary program 42 will be described. When the auxiliary program 42 is started based on a predetermined execution instruction from the OS 21 or the universal printing program 41, the auxiliary program 42 executes a process corresponding to the predetermined execution instruction.

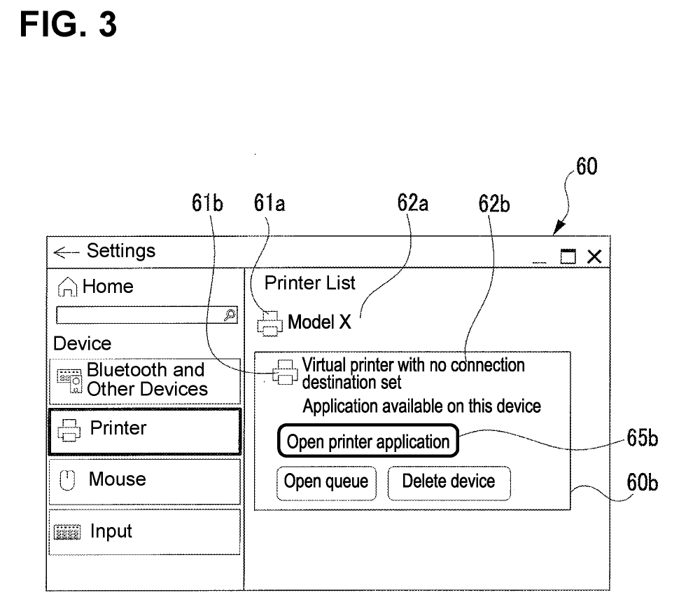

FIG. 3 illustrates a printer list screen 60 among the screens displayed by the OS 21. The printer list screen 60 is used for displaying a list of printer queues provided in the OS 21. In the PC 1, for example, as illustrated in FIG. 1, a physical printer queue 22a and a virtual printer queue 22b are provided in the OS 21. In this case, the printer list screen 60 displays an icon 61a and a name 62a corresponding to the physical printer queue 22a. Further, the printer list screen 60 displays an icon 61b and a name 62b corresponding to the virtual printer queue 22b.

In this specification, the physical printer queue 22a is a printer queue for the printer 31, and the name 62a is "Model X". For example, the model name of the printer 31 is set as the name 62a of the physical printer queue 22a. It is assumed that the physical printer queues 22a corresponding to the printer 32 and the printer 33 are not created. The PC 1 has the auxiliary program 42 for the virtual printer installed. FIG. 3 illustrates a state immediately after the auxiliary program 42 for the virtual printer has been installed, in which the physical printer that is the control printer has not yet been identified. Thus, the name 62b of the virtual printer queue is set to "virtual printer with no connection destination".

When an icon corresponding to a printer queue is operated, the printer list screen 60 displays an information screen for each printer queue corresponding to the operated icon. For example, FIG. 3 illustrates the information screen 60b when the icon 61b corresponding to the virtual printer queue 22b is operated. The information screen 60b includes various buttons including an "Open printer application" button 65b. When the physical printer that is the control target is identified, the information screen 60b may include status information of the physical printer that is the control target. When the physical printer that is the control target is not identified, the status information is not displayed.

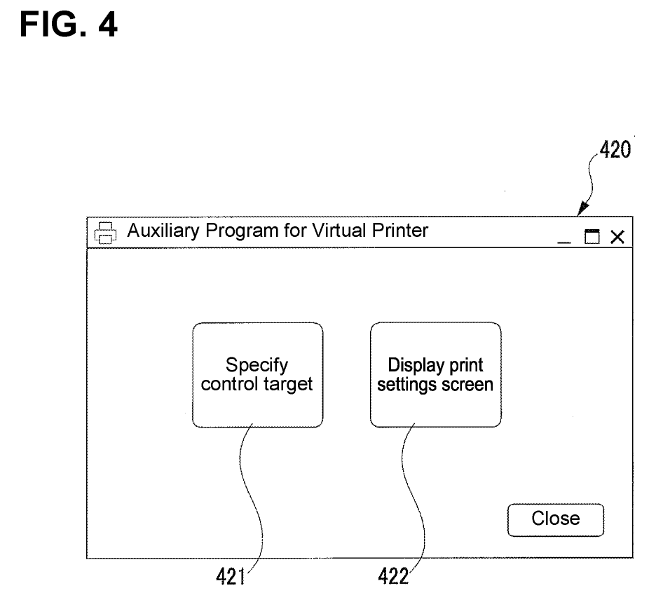

When the "Open printer application" button 65b is operated, the OS 21 starts the auxiliary program 42 associated with the virtual printer queue 22b. In this case, the OS 21 starts the auxiliary program 42 in a state where the virtual printer queue 22b is selected. The auxiliary program 42, when started in response to an instruction from the OS 21, causes the display 13a of the user IF 13 to show a home screen 420 as illustrated in FIG. 4. The home screen 420 includes a "Specify control target" button 421 and a "Display print settings screen" button 422. In response to receiving the operation of the "Display print settings screen" button 422, the auxiliary program 42 displays an advanced settings screen corresponding to the printer identified as the control target. When the printer that is the control target has not been identified, the "Display print settings screen" button 422 is shown grayed out and cannot be operated.

### Procedure for Renaming a Virtual Printer Queue

Next, the procedure for renaming the virtual printer queue 22b will be described in two embodiments. The first embodiment involves using only the virtual printer queue 22b created during installation of the auxiliary program 42. The second embodiment allows for the use of multiple virtual printer queues 22b to be created after the installation, in addition to the virtual printer queue 22b created during the installation.

### First Embodiment

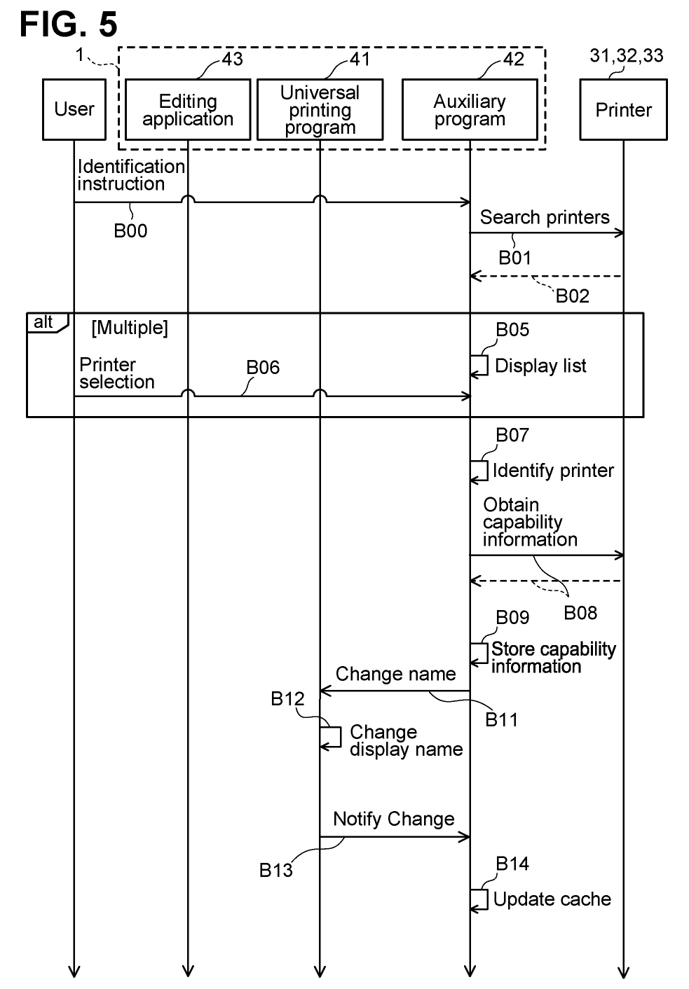

The first embodiment of changing the name of a virtual printer queue will be described with reference to the sequence diagram of FIG. 5. FIG. 5 illustrates the procedure of the auxiliary program 42 when the user operates the "Specify control target" button 421.

First, when the "Specify control target" button 421 is operated, the auxiliary program 42 is instructed to identify a printer as the control target (B00). Upon being instructed to identify the printer that is the control target, the auxiliary program 42 searches printers connected to the PC 1 (B01). The auxiliary program 42 broadcasts a search command, for example, thereby receiving responses from various printers supported by the auxiliary program 42 (B02). In B01, printers are searched using a specific communication method that is different from IPP. Thus, any printer capable of supporting the specific communication method may be able to respond. That is, regardless of IPP support, any printer that supports the specific communication method may be able to respond. For example, in this embodiment, responses are received not only from compatible printers such as the printer 31 and the printer 33, but also from incompatible printers such as the printer 32.

Upon receiving multiple responses (alt: [multiple]), the auxiliary program 42 displays a list of printers that responded (B05). Then, the auxiliary program 42 accepts a selection from the user (B06). The auxiliary program 42 displays a list of physical printers that the auxiliary program 42 can support based on the responses received in B02. The auxiliary program 42 supports multiple models. The auxiliary program 42 of this embodiment can support model X, model Y, and model Z. Thus, the physical printers 31, 32, and 33 are displayed as selectable options. The user can select the incompatible printer 32 as the printer that is the control target, for example.

The auxiliary program 42 identifies a printer as the control target from among the physical printers based on the user selection accepted in B06 (B07). When only one printer responds, the auxiliary program 42 identifies the responding printer as the printer that is the control target (B07). B07 is an example of identifying. When the incompatible printer 32 is selected, the incompatible printer 32 is identified as the printer that is the control target. The auxiliary program 42 may accept the selection of a printer by receiving input of an IP address or port number, without performing a printer search.

After identifying the printer that is the control target, the auxiliary program 42 transmits a command that requests capability information to the identified printer. Then, the auxiliary program 42 obtains the capability information from the identified printer (B08). When the identified printer is a compatible printer, the auxiliary program 42 requests the universal printing program 41 to obtain the capability information. The universal printing program 41obtains the capability information from the printer using IPP, and passes the obtained capability information to the auxiliary program 42. In contrast, when the identified printer is an incompatible printer, the auxiliary program 42 obtains the capability information using a communication method supported by the incompatible printer, instead of using IPP. For example, the auxiliary program 42 uses a management information base (MIB) to obtain capability information from the incompatible printer. In this case, the auxiliary program 42 directly communicates with the printer, not via the universal printing program 41. Alternatively, the auxiliary program 42 may communicate with the printer via a USB port.

The capability information obtained from the identified printer includes information about the formats of print data compatible with the identified printer. The capability information also includes information about the communication port or the IP address for transmitting the print data to the identified printer. In addition, the capability information includes information about the configurable print settings, the parameters that can be set for each setting, and default values for each setting. The capability information further includes information about the identified printer model. In addition, the capability information includes information about an image processing function that can be performed by the identified printer.

The auxiliary program 42 stores the capability information received from the identified printer (B09). The capability information that the auxiliary program 42 stores in the memory 12 may be all or part of the capability information obtained from the identified printer.

The auxiliary program 42 instructs the universal printing program 41 to change the name of the virtual printer queue 22b (B11). The instruction to change the name is accompanied by name information indicating the new name. The auxiliary program 42 creates name information when instructing the name change. The name information includes the model name of the identified printer. For example, when the identified printer is the printer 32, the auxiliary program 42 creates name information such as "virtual printer (model Y)". That is, the name is a combination of information indicating the virtual printer and "model Y," which is the model name of the printer 32. B11 is an example of setting. B11 is also an example of changing. The model name is an example of an identification name of the physical printer. Only the model name may be used as the name information.

Upon receiving the instruction to change the name, the universal printing program 41 changes the name of the virtual printer queue 22b to the name specified in the name information (B12). After changing the name of virtual printer queue 22b, the universal printing program 41 notifies the auxiliary program 42 of the completion of the change (B13). Upon receiving the notification of the change, the auxiliary program 42 updates the cache of the virtual printer queue 22b having a changed name (B14).

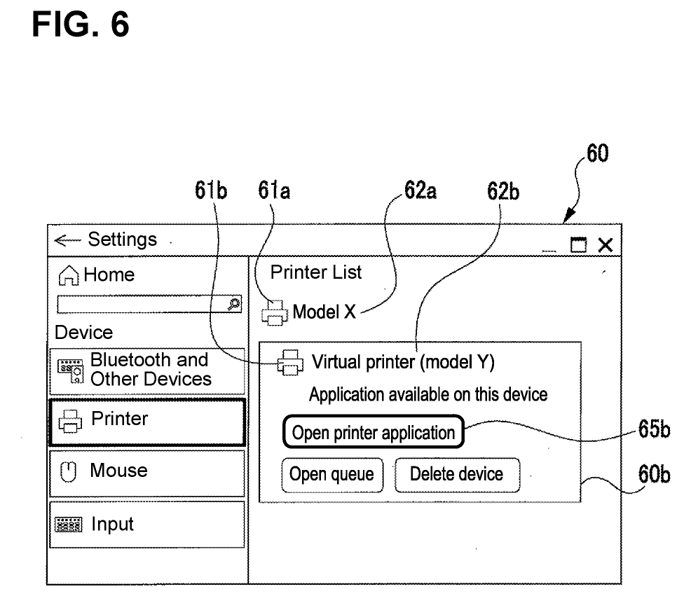

In the first embodiment, the auxiliary program 42 changes the name of the virtual printer queue 22b in accordance with the specification of the control target. Thus, when the name of the virtual printer queue 22b is displayed, the changed name is displayed. For example, on the printer list screen 60 provided in the OS 21, as illustrated in FIG. 6, the changed name of virtual printer queue 22b is displayed. By including the model name of the identified printer in the name of the virtual printer queue 22b, the user can easily recognize which printer is a control target. In addition, by using a name combined with information indicating that the printer is a virtual printer as in the present embodiment, the user can also recognize that the printer is a virtual printer. When the name consists only of the model name, the user can select the virtual printer without being aware that the printer is a virtual printer.

### Process for Performing Print Settings in Virtual Printer

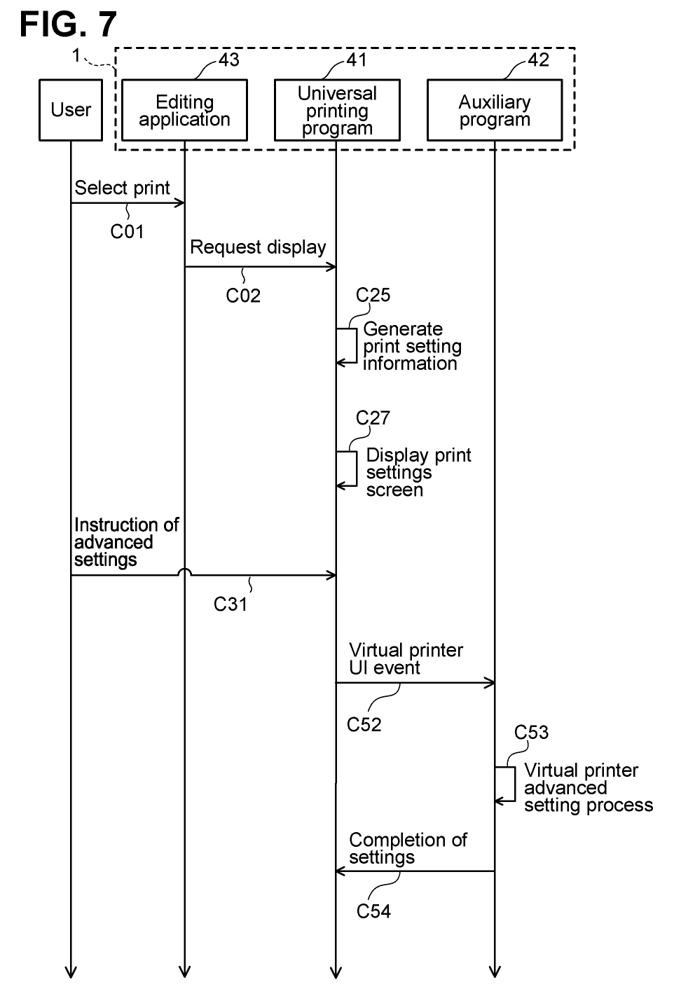

Next, a process for performing print settings in the virtual printer will be described. FIG. 7 illustrates a procedure for performing print settings from the editing application 43.

The editing application 43 can create and edit documents and images based on a user instructions. In a case where the user intends to print a document or image being displayed, the user selects “Print” on the editing application 43 (C01). For example, the user may select “Print” from a menu of operation items listed in the editing application 43. In response to receiving the selection of “Print”, the editing application 43 requests the universal printing program 41 to display a screen that accepts instructions related to printing (C02). In this embodiment, the virtual printer is set to the default, and C02 is a request in a state where the virtual printer queue 22b is selected.

The universal printing program 41 generates print setting information in response to a request from the editing application 43 in a state where the virtual printer queue 22b is selected (C25). In C25, the universal printing program 41 refers to the manifest of the auxiliary program 42 to generate print setting information. The manifest describes capability information relating to all functions that can be provided by every printer model that can be associated with the auxiliary program 42.

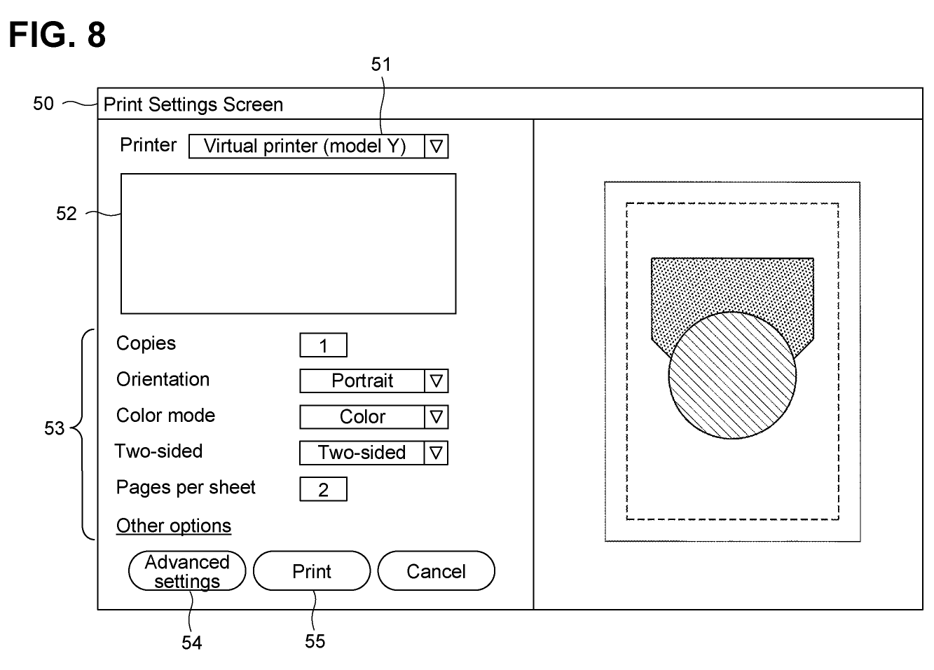

The universal printing program 41 causes the user IF 13 to display a print settings screen based on the print setting information generated in C25 (C27). FIG. 8 illustrates an example of a print settings screen displayed in C27. The print settings screen 50 includes a printer selection field 51, an information display field 52, basic print settings specification fields 53, an “Advanced settings” button 54, and a “Print” button 55. The print settings screen 50 accepts user instructions related to print settings that are available to the universal printing program 41. The editing application 43 may display the print settings screen 50.

The printer selection field 51 is used to select a printer for printing. The printer selection field 51 includes a printer that corresponds to the printer queue provided in the OS 21 as a selection option. The information display field 52 displays information specified by the auxiliary program corresponding to the printer selected in the printer selection field 51. Each of the basic print settings specification fields 53 is used for setting basic items such as the number of copies and the orientation of the document. The “Advanced settings” button 54 is used to configure settings that are not included in the basic print settings specification fields 53. The “Print” button 55 is used to receive a print execution instruction based on currently selected print settings.

When the print settings screen 50 is initially displayed, the universal printing program 41 selects a printer set as the default as a printer to be displayed in the printer selection field 51. Then, the universal printing program 41 obtains print setting information indicating print settings that can be configured on the printer set as the default. Then, the universal printing program 41 determines selectable options for each item in the print settings specification fields 53 based on the obtained print setting information.

The user can select a printer by operating the printer selection field 51. Selectable printers are those for which printer queues have been provided, and the names assigned to each printer queue are displayed as options in the list of the printer selection field 51. For example, after the processing of FIG. 5 is completed and the name of the virtual printer queue 22b is changed, the name "virtual printer (model Y)" is displayed as an option in the list of the printer selection field 51. When a printer is selected, the universal printing program 41 switches the contents of the print setting specification fields 53 to those appropriate for the selected printer. More specifically, the step of C02 and subsequent steps in FIG. 7 are executed in response to the selection of a printer.

After C27, upon receiving an operation to the “Advanced settings” button 54 of the print settings screen 50 (C31), the universal printing program 41 issues an event for displaying an advanced settings screen. That is, when the “Advanced settings” button 54 is operated, the universal printing program 41 starts the auxiliary program 42 and issues a UI event corresponding to the selected printer.

For example, when a virtual printer is selected, the universal printing program 41 issues a virtual printer UI event as a UI event corresponding to the virtual printer (C52). Upon receiving the virtual printer UI event, the auxiliary program 42 executes a virtual printer advanced setting process (C53). In the virtual printer advanced setting process, the auxiliary program 42 causes the display 13a of the user IF 13 to display an advanced settings screen for accepting advanced print settings. The virtual printer UI event is an example of an instruction to display a print settings screen. C53 is an example of displaying.

Specifically, the auxiliary program 42 determines the type of the identified physical printer. For example, the auxiliary program 42 may obtain the type from the identified physical printer or may obtain the type using a cache. Then, the auxiliary program 42 causes the display 13a of the user interface 13 to display an advanced settings screen for accepting advanced print settings related to printing by the physical printer according to the type of the physical printer. When the printer that is the control target has not been identified, a procedure for identifying the printer that is the control target (processing from B01 to B09 in FIG. 5) may be performed.

For example, the printer 31 is a large printer capable of post-processing operations such as stapling, and the printer 32 is a label printer capable of printing on roll paper. In this case, the advanced settings screen where the printer 31 is identified as the control target includes settings for post-processing operations, whereas selection of roll paper as the paper type is not allowed. Conversely, the advanced settings screen where the printer 32 is identified as the control target allows selection of roll paper as the paper type, whereas settings for the post-processing operations are not included.

The user determines print settings to be used on the advanced settings screen. When the auxiliary program 42 receives an operation to close the advanced settings screen, the auxiliary program 42 closes the advanced settings screen and notifies the universal printing program 41 that the settings have been completed (C54).

### Process of Executing Printing in Virtual Printer

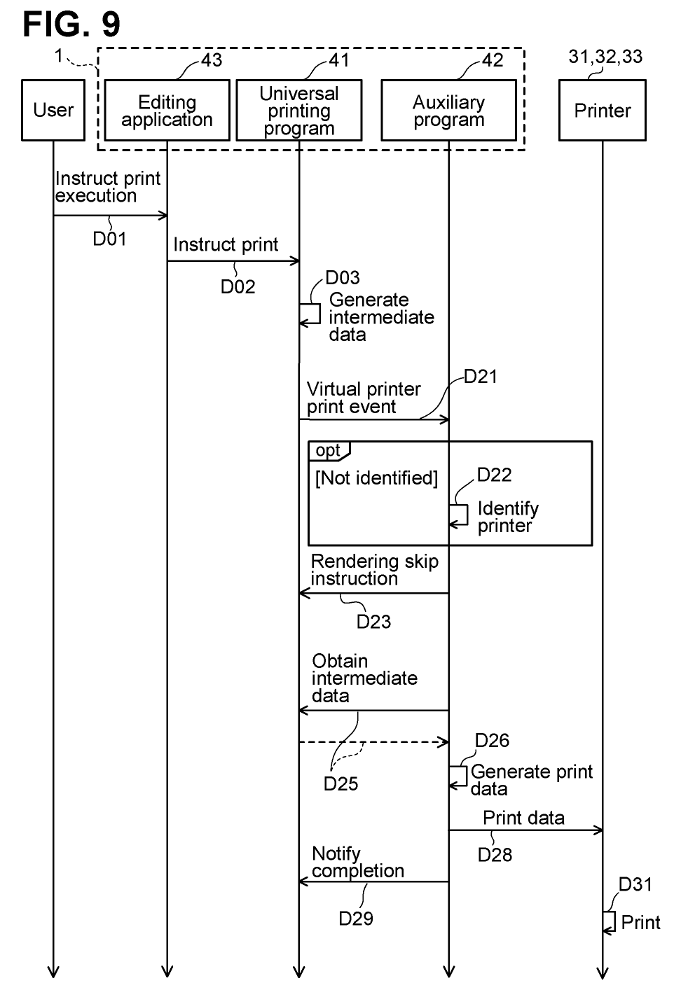

Next, a process for performing printing on a printer that is the control target of the virtual printer will be described. FIG. 9 illustrates a printing procedure from the editing application 43.

The user determines an image to be printed using the editing application 43. In a state where the printer to perform printing is selected, the user inputs a print execution instruction in the editing application 43 (D01). Upon receiving the print execution instruction, the editing application 43 determines that it has received an instruction for the universal printing program 41 to print the selected image on the selected printer. The editing application 43 outputs the information of the received print execution instruction to the universal printing program 41 (D02).

The universal printing program 41 obtains, as the information of the print instruction, at least information indicating image data that represents an image to be printed from the editing application 43. The universal printing program 41 may obtain information of print settings. The universal printing program 41 generates intermediate data based on the information obtained from the editing application 43 (D03). In D03, intermediate data is generated by converting the image data of the image to be printed into a predetermined format.

The image data obtained from the editing application 43 may be of various types. The universal printing program 41 thus converts the image data to be printed into intermediate data suitable for generating print data. When the image data to be printed is suitable for generating print data, the generation of intermediate image data may be omitted, and the image data may be used directly as intermediate image data. When the image data included in the editing application 43 is not suitable for processing by the universal printing program 41, the universal printing program 41 may skip D03. Alternatively, the image data obtained from the editing application 43 may be used directly as the intermediate data. After generating the intermediate data, the universal printing program 41 issues a print event for causing the printer that is the control target to perform printing. That is, after generating the intermediate data, the universal printing program 41 starts the auxiliary program 42 and issues a print event corresponding to the selected printer.

For example, when a virtual printer is selected, the universal printing program 41 issues a virtual printer print event as a print event corresponding to the virtual printer (D21). When the virtual printer print event is issued, the auxiliary program 42 determines whether a printer that is the control target of the virtual printer has been identified. When the physical printer that is the control target of the virtual printer is not identified, the auxiliary program 42 executes a process for identifying the printer that is the control target (D22). For example, the auxiliary program 42 may perform a procedure for identifying a printer that is the control target (processing from B01 to B09 in FIG. 5).

After D22, or when the physical printer that is the control target has been identified, the auxiliary program 42 performs processing for transmitting a print job to the identified printer. That is, the auxiliary program 42 first passes an instruction to the universal printing program 41 to skip rendering by the universal printing program 41 (D23). The auxiliary program 42 obtains the intermediate data generated by the universal printing program 41 (D25).

The auxiliary program 42 edits the obtained intermediate data as necessary. Then, based on the intermediate data and the print settings, the auxiliary program 42 generates print data in a format compatible with the identified physical printer (D26). The auxiliary program 42 can generate print data in a format that can be printed by the identified physical printer even if the format is not compatible with IPP. If the print data that can be used for printing by the identified physical printer can be generated by the universal printing program 41, the universal printing program 41 may be used to generate the print data.

Then, the auxiliary program 42 transmits a print job including the generated print data to the identified physical printer (D28). The auxiliary program 42 transmits the print data to the identified physical printer using a communication protocol suitable for the identified physical printer. Thus, the auxiliary program 42 can transmit the print data even if the destination printer does not support IPP. When the destination printer supports IPP, the universal printing program 41 may be used to transmit the print data. After transmitting the print data to the identified physical printer, the auxiliary program 42 notifies the universal printing program 41 of the completion of the print event (D29).

Upon receiving the print job from the PC 1, the identified physical printer performs printing based on the print data included in the received print job (D31). Since the auxiliary program 42 transmits a print job suitable for the identified physical printer, the identified physical printer can print appropriately based on the print job.

### Application Example of First Embodiment

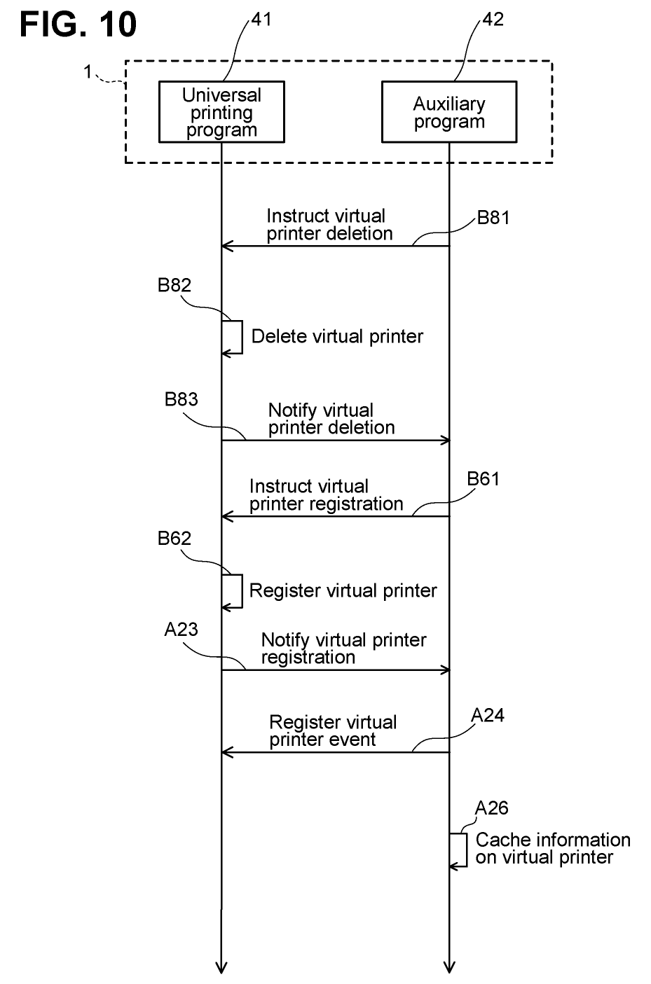

In the first embodiment described above, the auxiliary program 42 issues an instruction to the universal printing program 41 to change the name of the virtual printer queue. However, the universal printing program 41 may not support such a name change instruction. In such cases, the procedure will be described as an application example of the first embodiment with reference to the sequence diagram in FIG. 10.

The sequence diagram in FIG. 10 shows the procedure after B09 in FIG. 5. After B09, the auxiliary program 42 instructs the universal printing program 41 to delete the virtual printer queue 22b currently selected (B81). The universal printing program 41 deletes the selected virtual printer queue 22b in response to the deletion instruction from the auxiliary program 42 (B82). After deleting the virtual printer queue 22b, the universal printing program 41 notifies the auxiliary program 42 of the deletion of the virtual printer queue (B83). B81 is an example of deleting.

In response to the deletion notification from the universal printing program 41, the auxiliary program 42 instructs the universal printing program 41 to register a virtual printer queue 22b (B61). B61 is basically the same procedure as A21. Thus, the universal printing program 41 creates a new virtual printer queue 22b and registers a virtual printer corresponding to the newly created virtual printer queue 22b in accordance with the instruction in B61 (B62). However, when instructing the registration of the virtual printer, the auxiliary program 42 creates name information in the same manner as in the case of the name change. The name information includes the model name of the printer identified in B07 illustrated in FIG. 5. In B61, the name of a virtual printer queue 22b to be newly created is set to the name indicated in the created name information. Thus, a new virtual printer queue 22b having a name indicated in the name information is created. B61 is an example of setting.

After the registration of the virtual printer, the auxiliary program 42 receives the notification of the registration of the virtual printer (A23) and registers an event for the virtual printer (A24). The auxiliary program 42 also caches the information of the newly created virtual printer queue 22b (A26). A series of steps from B81 to B61 in FIG. 10 is an example of setting and an example of changing.

### Second Embodiment

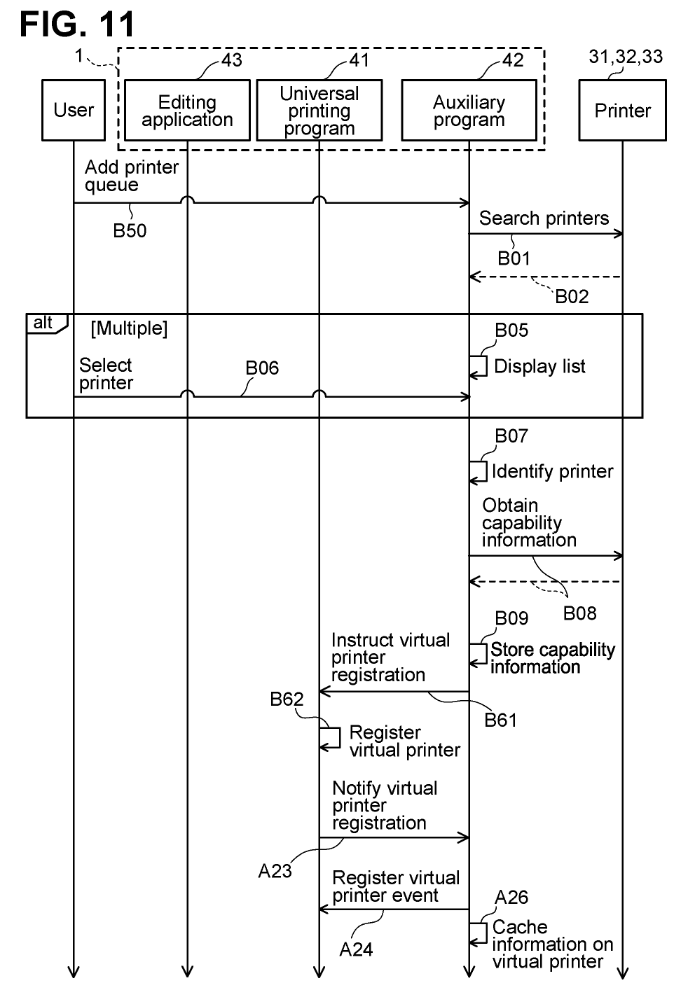

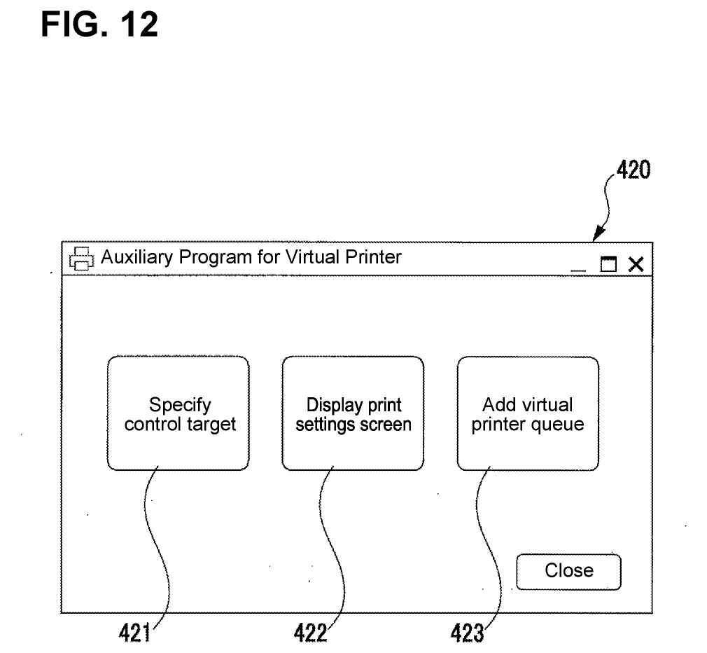

A second embodiment of changing the name of a virtual printer queue will be described with reference to the sequence diagram of FIG. 11. In the second embodiment, multiple virtual printer queues 22b are provided in the OS 21. Thus, the home screen 420 in the second embodiment includes an "Add virtual printer queue" button 423 as illustrated in FIG. 12. FIG. 11 shows the procedure of the auxiliary program 42 when the "Add virtual printer queue" button 423 is operated by the user. The same steps as those illustrated in the sequence diagrams of FIG. 2, FIG. 5, and FIG. 10 are denoted by the same reference numerals, and the descriptions thereof are omitted.

First, the "Add virtual printer queue" button 423 is operated, and the auxiliary program 42 is instructed to add a virtual printer queue 22b (B50). Upon receiving the instruction to add the virtual printer queue 22b, the auxiliary program 42 searches printers connected to the PC 1 (B01). The steps from B01 to B09 illustrated in FIG. 11 are the same as those in FIG. 5. B07 is an example of identifying.

After B09, the auxiliary program 42 instructs the universal printing program 41 to register a virtual printer (B61). The auxiliary program 42 creates name information when instructing the registration of a virtual printer queue 22b. The name information includes the model name of the identified printer.

The universal printing program 41 creates a new virtual printer queue 22b in response to the registration instruction from the auxiliary program 42 (B62). The created name information is added to the registration instruction. The universal printing program 41 sets the name of the virtual printer queue 22b to the name indicated in the name information added to the registration instruction. The steps of B61 and B62 illustrated in FIG. 11 are the same as those in FIG. 10. Even in this procedure, the name of the newly created virtual printer queue 22b will be the name indicated in the name information.

After the completion of the step of B62, the universal printing program 41 notifies the auxiliary program 42 that the registration of the virtual printer has been completed (A23). The auxiliary program 42, upon receiving the notification of A23, registers events for the virtual printer in the universal printing program 41 (A24). The auxiliary program 42 caches the information of the registered virtual printer queue 22b in response to the notification of A23 (A26).

In the second embodiment, when adding the virtual printer queue 22b, the auxiliary program 42 also identifies a physical printer that is the control target. Further, the auxiliary program 42 sets the model name of the identified physical printer to the name of the virtual printer queue 22b to be added. This allows the user to understand which printer is the control target of the virtual printer queue 22b to be added.

In the second embodiment, when a virtual printer queue 22b is added, the physical printer that is the control target is also identified, but the control target may not be specified. In this case, just as during installation, the name of the created virtual printer queue 22b is set to "virtual printer with no connection destination”. In this case as well, simply starting the auxiliary program with the newly created virtual printer queue 22b selected is sufficient. Further, by operating the "Specify control target" button 421 on the home screen 420 of the started auxiliary program 42, the physical printer that is the control target may be identified in the same way as in the first embodiment. Thus, the name of the newly created virtual printer queue 22b is changed to the model name of the identified physical printer.

In the second embodiment, the auxiliary program 42 may receive a deletion instruction of the virtual printer queue 22b from the home screen 420. In this case, the auxiliary program 42 only needs to instruct the universal printing program 41 to delete the selected virtual printer queue 22b. Alternatively, the auxiliary program 42 may obtain a list of the virtual printer queues 22b associated with the auxiliary program 42 from the universal printing program 41 and accept the selection of the deletion target. In this case, the auxiliary program 42 only needs to instruct the universal printing program 41 to delete the selected virtual printer queue 22b. The procedure of instructing the universal printing program 41 to delete the virtual printer queue 22b is an example of deleting.

### Application Example of Second Embodiment

In the second embodiment described above, when adding the virtual printer queue 22b, the auxiliary program 42 instructs the registration of the virtual printer at a timing different from that of installation. The universal printing program 41 creates a new virtual printer queue 22b in response to the registration instruction from the auxiliary program 42. However, the auxiliary program 42 may not be able to instruct the registration of the virtual printer except during installation. For example, if the auxiliary program 42 is located within a sandbox, the OS 21 may restrict operations such as adding printer queues.

In the application example of the second embodiment, the PC 1 is provided with an intermediate application 49, which is a Win32 application located outside the sandbox where the auxiliary program 42 is located (refer to FIG. 1). The intermediate application 49 is located outside the sandbox and thus can relay the instruction from the auxiliary program 42 to the universal printing program 41.

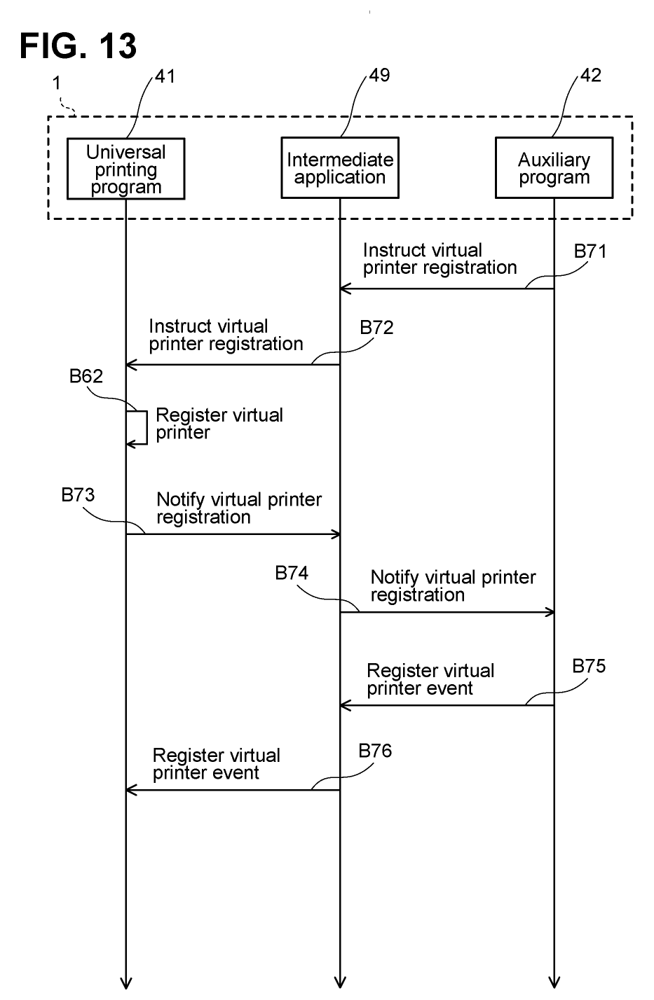

The sequence diagram of FIG. 13 illustrates a procedure after B09 in FIG. 11 in the application example of the second embodiment. After B09 in FIG. 11, the auxiliary program 42 first instructs the intermediate application 49 to register a virtual printer (B71). The intermediate application 49 then instructs the universal printing program 41 to register a virtual printer (B72). That is, B71 and B72 implement the step of B61. B 71 and B72 are examples of setting. The universal printing program 41 creates a virtual printer queue 22b and registers the virtual printer in accordance with the instruction in B72. In this case as well, the auxiliary program 42 creates name information and adds it to the registration instruction. The name information includes the model name of the identified printer.

Upon receiving the registration instruction from the intermediate application 49, the universal printing program 41 creates a new virtual printer queue 22b and registers the virtual printer in accordance with the instruction in B72 (B62). B62 in FIG. 13 is the same as that in FIG. 10. The universal printing program 41 sets the name of the newly created virtual printer queue 22b to the name indicated in the name information. Thus, a new virtual printer queue 22b having a name indicated in the name information is created.

Thereafter, the intermediate application 49 relays the notification from the universal printing program 41 to the auxiliary program 42. That is, after the completion of the step of B62, the universal printing program 41 notifies the intermediate application 49 that the registration of the virtual printer is completed (B73). The intermediate application 49 receives the notification in B73 and notifies the auxiliary program 42 (B74). The auxiliary program 42 instructs the intermediate application 49 to register events for the virtual printer (B75). The intermediate application 49 instructs the universal printing program 41 to register various events for the virtual printer (B76). Consequently, the auxiliary program 42 instructs the universal printing program 41, via the intermediate application 49, to register various events for the virtual printer.

The procedure of the application example of the second embodiment can also be applied to the procedure of the application example of the first embodiment. That is, even in the application example of the first embodiment, when the registration of the virtual printer cannot be instructed except during installation of the auxiliary program 42, the registration of the virtual printer may be instructed using the intermediate application 49.

### Processing of Synchronizing Virtual Printer Queue and Cache

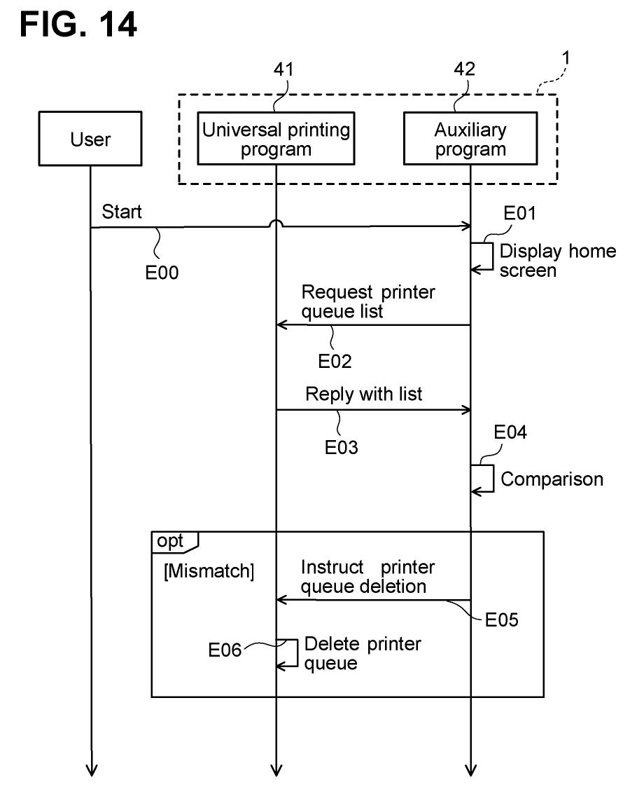

Next, a processing procedure for synchronizing the virtual printer queue and the cache will be described as processing relating to the second embodiment. In the second embodiment, a virtual printer queue 22b can be added at times other than the installation of the auxiliary program 42. As a result, due to various factors, the actual configuration of the virtual printer queues 22b and the cache may become inconsistent. FIG. 14 is a sequence diagram illustrating a procedure for synchronizing the cache with the actual configuration of the virtual printer queues 22b when such an inconsistency occurs.

First, the auxiliary program 42 for the virtual printer is started by user operation (E00). When started, the auxiliary program for the virtual printer displays the home screen 420 on the display 13a of the user IF 13 (E01). The auxiliary program 42 may be started automatically by another application, such as a service, and is not limited to being started by user operation. In this case, an option to suppress the display of the home screen may be provided, and the display of the home screen 420 may be omitted.

The auxiliary program 42 for the virtual printer further requests, from the universal printing program 41, a list of the virtual printer queues 22b associated with the auxiliary program 42 (E02). In response to the request from the auxiliary program 42, the universal printing program 41 replies with a list of the virtual printer queues 22b associated with the requesting auxiliary program 42 (E03). The reply includes identification information and a name for each virtual printer queue 22b. E02 is an example of obtaining a list.

The auxiliary program 42, having obtained the list of the virtual printer queues 22b, reads the information for each virtual printer queue 22b from the cache and compares the information with the obtained list (E04). That is, when a virtual printer is registered, the auxiliary program 42 caches information of the corresponding virtual printer queue 22b created during registration. Thus, the auxiliary program 42 determines whether the actual configuration of the virtual printer queues 22b in the OS 21 matches the information in the cache.

For example, a virtual printer queue 22b may be deleted through a user operation on the information screen 60b of the printer list screen 60. In this case, the actual configuration of the virtual printer queues 22b does not match the information in the cache. The auxiliary program 42 may have a function that automatically deletes the cache of a virtual printer queue 22b not used for a certain period. In this case as well, the actual configuration of the virtual printer queues 22b may not match the information in the cache. When a virtual printer queue 22b that the user does not intend is created, the actual configuration of the virtual printer queues 22b does also not match the information in the cache.

When the comparison result indicates a mismatch (opt: mismatch), the auxiliary program 42 requests the universal printing program 41 to delete a virtual printer queue 22b (E05). The deletion request includes identification information of any virtual printer queue 22b not in the cache. The universal printing program 41 deletes any virtual printer queue 22b that is not in the cache in response to the request from the auxiliary program 42 (E06). E05 is an example of synchronizing.

By deleting a virtual printer queue 22b that is not in the cache, an unnecessary virtual printer queue 22b can be automatically deleted. For example, by deleting a virtual printer queue 22b that is no longer used, resources can be utilized more efficiently. Even when a virtual printer queue 22b is deleted, the auxiliary program 42 for the virtual printer is not uninstalled. Thus, when a virtual printer is used, a virtual printer queue 22b can be simply added again by the auxiliary program 42.

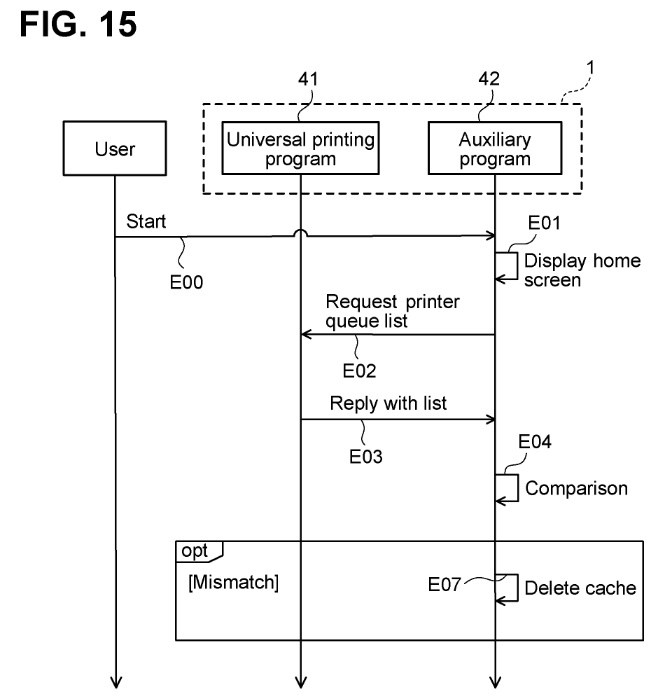

In the procedure illustrated in FIG. 14, when the comparison result indicates a mismatch, any virtual printer queue 22b that is not in the cache is deleted to match the cache. On the other hand, as another embodiment, when a mismatch is detected, the cache may be deleted to match the actual configuration of the virtual printer queues 22b. FIG. 15 is a sequence diagram illustrating, as another embodiment, a procedure for synchronizing the cache with the actual configuration of the virtual printer queues 22b when the actual configuration of the virtual printer queues does not match the cache. The same steps as those illustrated in the sequence diagram of FIG. 14 are denoted by the same reference numerals, and the descriptions thereof are omitted.

In another embodiment as well, when the auxiliary program 42 for the virtual printer is started, the home screen 420 is displayed (E01). Then, the auxiliary program 42 obtains a list of the virtual printer queues 22b associated with the auxiliary program 42 (E02, E03). The auxiliary program 42 reads the information of the virtual printer queues 22b from the cache and compares the information with the obtained list (E04).

When the comparison result indicates a mismatch (opt: mismatch), the auxiliary program 42 deletes the cache of any virtual printer queue 22b that is not in the obtained list (E07). By deleting the cache of any virtual printer queue 22b that is not in the list, the cache will match the actual configuration of the virtual printer queues 22b. E7 is an example of synchronizing.

As described above in detail, the auxiliary program 42 sets the name of the virtual printer queue to the model name of the physical printer that is the control target. Thus, when a printer is selected, a virtual printer is displayed not with the predetermined name of the virtual printer queue 22b but with the model name of the physical printer that is the control target. Thus, the user can easily select the printer. Furthermore, the user can easily understand which printer is set as the control target for the virtual printer.

The embodiments disclosed herein are merely illustrative and are not intended to limit the present invention in any way. Accordingly, the technology disclosed in the present specification may be naturally improved and modified in various ways without departing from the spirit thereof. For example, four or more printers may be connected to the PC 1.

In addition, the screens to be displayed on the user IF 13 are all examples, and are not limited to the illustrated examples. The words, object shapes, and screen backgrounds shown in the illustrated screens and screen layouts are all examples.

The timing for identifying the printer that is the control target of the virtual printer is not limited to the operation of the "Specify control target" button 421. For example, identification may be performed when the virtual printer is selected while its control target is still unspecified. Alternatively, identification may be performed when the advanced settings screen may be displayed while the control target is unspecified. Alternatively, identification may be performed when a print instruction is issued while the control target is unspecified. Alternatively, identification may be performed immediately after installation. When a control target printer has already been identified, the control target printer may be changed. When the control target printer is changed, the name of the virtual printer queue 22b may be changed to the model name of the printer after the change.

Alternatively, the procedure for identifying a printer that is the control target of the virtual printer may be executed automatically at the timing when the auxiliary program 42 is started. That is, the auxiliary program 42 may search printers (B01, B02) at the time of startup and display the list of the searched printers as the initial screen (B05). Then, the auxiliary program 42 may identify the printer selected by the user on the initial screen as the printer that is the control target (B07). In this case as well, the procedure for changing the name (B11 to B14) or the procedure for adding the virtual printer queue (B61 to A26) may be executed. That is, the procedure for changing the name (B11 to B14) may also be executed automatically, in addition to being triggered by the operation of the "Specify control target" button 421. That is, the procedure for adding a virtual printer queue (B61 to A26) may be executed automatically, in addition to being triggered by the operation of the "Add virtual printer queue" button 423.

The auxiliary program 42 sets the name of the virtual printer queue 22b to the model name of the physical printer that is the control target. Any name that allows the identification of the printer that is the control target may be used, such as the node name of the printer. Alternatively, a name entered by the user may be used.

The auxiliary program 42 may accept an instruction to change the name of the selected virtual printer queue 22b. For example, the auxiliary program 42 displays a button for changing the name on the home screen 420 or the advanced settings screen. In response to the operation of the button, the auxiliary program 42 accepts an input of a new name. When a new name is input, the auxiliary program 42 may instruct the universal printing program 41 to change the name. The inputted name is given to the name change instruction. The universal printing program 41 may set the name given to the name change instruction as the name of the virtual printer queue 22b. Thus, a name entered by the user can be set as the name of the virtual printer queue 22b.

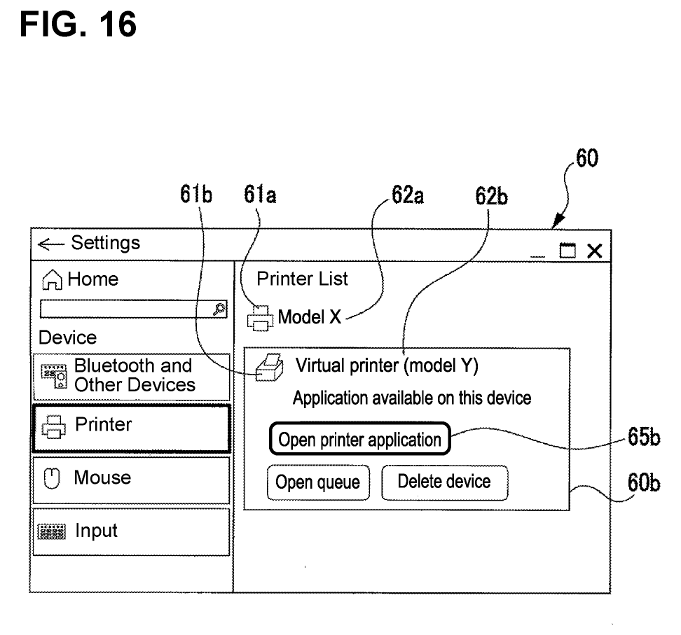

The auxiliary program 42 may set an icon of the virtual printer queue 22b, in addition to the name of the virtual printer queue 22b. The auxiliary program 42 stores icons for each model, and reads out the icon corresponding to the model of the identified physical printer. Alternatively, the auxiliary program 42 obtains an icon corresponding to the model from the server of the vendor of the identified physical printer. Then, the auxiliary program 42 adds an icon corresponding to the model of the identified physical printer to the registration instruction. The universal printing program 41 may set the icon added to the registration instruction as the icon of the virtual printer queue 22b. Thus, as illustrated in FIG. 16, for example, in addition to the name 62b of the virtual printer queue 22b, the icon 61b is also displayed in accordance with the model. Thus, the user can easily identify the printer.

In the present embodiment, the description has been provided only for the printing operation in which the auxiliary program 42 is involved. However, the auxiliary program 42 may be involved in operations other than the printing operation. The program for executing the processing of this embodiment is not limited to the auxiliary program 42. That is, the program may be any program that receives instructions from the OS 21 or the universal printing program 41 when printing using the universal printing program 41 is performed. For example, a print workflow application (Print Workflow) for which the specifications have been disclosed by Microsoft Corporation may be used.

The execution timing of the auxiliary program 42 is not limited to the examples of the embodiments. For example, the auxiliary program 42 may be executed upon receiving a direct execution instruction from the OS 21, or the auxiliary program 42 may be a resident program. When the auxiliary program 42 is resident, the auxiliary program 42 may perform the above-described operations in response to receiving an execution instruction.

In any sequence diagram disclosed in the embodiments, steps may be executed in a different order or in parallel, provided no inconsistency arises in the contents of the procedures.

The processing in all steps disclosed in the embodiments may be executed by hardware, such as a single CPU, multiple CPUs, or an ASIC. Alternatively, the processing may be performed by a combination thereof. The processing in all steps disclosed in the embodiments may be implemented in a recording medium storing a computer-readable program for executing the processing. Alternatively, the processing may be implemented in various forms such as a method.

While the disclosure has been described in detail with reference to the specific embodiment thereof, this is merely an example, and various changes, arrangements and modifications may be applied therein without departing from the spirit and scope of the disclosure.

What is claimed is:

1. A non-transitory computer-readable storage medium storing a support program that, when executed by a computer of an information processing apparatus, causes the information processing apparatus to perform operations comprising:
identifying a physical printer that is a control target of a virtual printer associated with the support program;
setting a name of a printer queue of the virtual printer as an identification name of the physical printer identified in the identifying; and
in a case where, when the printer queue of the virtual printer is selected on a printer selection screen displayed by an application program of the information processing apparatus, an operating system, which includes a universal printing program, in the information processing apparatus issues an instruction to display a print settings screen,
displaying, on a user interface of the information processing apparatus, the print settings screen based on capabilities of the physical printer identified.

2. The non-transitory computer-readable storage medium according to claim 1,
wherein the information processing apparatus includes a first printer queue of a first virtual printer that is created after installation of the support program and associated with the support program, and
wherein the first printer queue is the printer queue, the name of which is set in the setting as the identification name of the physical printer identified.

3. The non-transitory computer-readable storage medium according to claim 2, wherein the support program, when executed by the computer, causes the information processing apparatus to further perform operations comprising:
wherein the information processing apparatus further includes a second printer queue of a second virtual printer that is created during installation of the support program and associated with the support program,
receiving, via the user interface, a deletion instruction to delete a printer queue, the printer queue being selected from the first printer queue and the second printer queue; and
deleting the printer queue selected in response to receiving the deletion instruction.

4. The non-transitory computer-readable storage medium according to claim 2,
wherein the information processing apparatus instructs the operating system to create the first printer queue having the identification name of the physical printer identified, and
wherein the operating system creates the first printer queue.

5. The non-transitory computer-readable storage medium according to claim 2,
wherein the information processing apparatus includes an intermediate program that is a Win 32 application and located outside a sandbox where the support program is located,
wherein the information processing apparatus instructs the intermediate program to cause the operating system to create the first printer queue having the identification name of the physical printer identified, and
wherein the operating system creates the first printer queue.

6. The non-transitory computer-readable storage medium according to claim 3, wherein the support program, when executed by the computer, causes the information processing apparatus to further perform operations comprising:
caching information related to a plurality of printer queues corresponding to respective virtual printers associated with the support program, the plurality of printer queues including the first printer queue and the second printer queue;
obtaining, from the operating system, a list of a plurality of printer queues corresponding to respective virtual printers associated with the support program; and
synchronizing the plurality of printer queues in the list obtained in the obtaining and the plurality of printer queues in the information cached in the caching.

7. The non-transitory computer-readable storage medium according to claim 2, wherein the first printer queue set with the identification name of the physical printer identified is set with an icon corresponding to a model of the physical printer identified.

8. The non-transitory computer-readable storage medium according to claim 2,
wherein, when a physical printer that is a control target of the virtual printer is identified in the identifying, the information processing apparatus creates the first printer queue that is set with, as a name of the new first printer queue, the identification name of the physical printer identified, and
wherein, when a physical printer that is a control target of the virtual printer is not identified in the identifying, the information processing apparatus creates a printer queue that is set with, as a name of the new first printer queue, a predetermined name indicating that a physical printer that is a control target is not identified.

9. The non-transitory computer-readable storage medium according to claim 8, wherein the support program, when executed by the computer, causes the information processing apparatus to further perform operations comprising:
wherein the information processing apparatus further includes a second printer queue of a second virtual printer that is created during installation of the support program and associated with the support program,
receiving, via the user interface, an instruction to change a name of a printer queue, the printer queue being selected from the first printer queue and the second printer queue, and
changing the name of the printer queue selected to the identification name of the physical printer identified.

10. The non-transitory computer-readable storage medium according to claim 1,
wherein the printer queue of the virtual printer is created by the operating system in response to installation of the support program and is set with, as a name of the printer queue, a predetermined name indicating that a physical printer as a control target of the virtual printer is not identified,
wherein the setting further comprises changing the name of the printer queue that is set with the predetermined name to the identification name of the physical printer identified.

11. The non-transitory computer-readable storage medium according to claim 10, wherein the changing is performed in response to the identifying.

12. The non-transitory computer-readable storage medium according to claim 10,
wherein the support program, when executed by the computer, causes the information processing apparatus to further perform operations comprising receiving, via the user interface, an instruction to change the name of the printer queue, and
wherein the information processing apparatus performs the changing in response to receiving the instruction to change the name of the printer queue.

13. The non-transitory computer-readable storage medium according to claim 10, wherein the changing comprises changing an icon for the printer queue to an icon corresponding to a model of the physical printer identified.
